(19) United States
(12) Patent Application Publication
(10) Pub. No.: US 2004/0133666 A1
(43) Pub. Date: Jul. 8, 2004

(54) Application of active networks to load distribution in a plurality of service servers

(75) Inventors: Olivier Marce, Massy (FR); Carlo Drago, Paris (FR); Laurent Clevy, Chartres (FR); Olivier Le Moigne, Ottawa (CA); Philippe Bereski, Morsang Sur Orge (FR); Jean-Francois Cartier, Treillieres (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/454,496

(22) Filed: Jun. 5, 2003

(30) Foreign Application Priority Data
Jun. 6, 2002 (FR) 02 06 961

(51) Int. Cl. G06F 15/177; G06F 15/173

(52) U.S. Cl. 709/222; 709/223

(57) ABSTRACT

The invention relates to network equipment (E₁, E₂, E₃) for transmitting data packets, some of which contain requests for a service implemented by a plurality of servers (S₁, S₂, S₃), which network equipment is characterized in that it includes means for receiving data packets containing or referring to executable code adapted to distribute said service requests among said plurality of servers and means for deciding to transmit said data packets to another network equipment or to execute said executable code.

The present invention relates to load distribution in a set of servers implementing the same service. The invention applies particularly well to active networks.

Various prior art solutions are described, for example, in the article “Load Balancing your Web site—Practical approaches for distributing HTTP traffic” by Ralf S. Engelschall, published in “New architect” in 1998. The article is available on the Internet at the following address, for example:

http://www.webtechniques.com/archives/1998/05/engelschall/

FIG. 1 shows a first prior art solution. In the above article, this first solution is referred to as “The reverse proxy approach”.

Equipment (not shown) transmits a service request R. The request is conveyed by the network N. The required service is implemented by a plurality of servers S₁, S₂ and S₃. A device D upstream of these servers handles load distribution. It is this device which is referred to as the “reverse proxy” in the article by Ralf S. Engelschall.

On receiving the service request R, this device decides to transmit it to the server S₁ (request R₁), to the server S₂ (request R₂), or to the server S₃ (request R₃). In the server to which the request is addressed, this choice can depend on simple rules: for example, the device D can transmit the service requests in order to each server in turn.

The main drawback of this approach is the lack of flexibility in terms of topology. For a set of services S₁, S₂, S₃ to be able to benefit from the load distribution function, it is necessary for the servers to be situated so that all requests addressed to them pass through the device D.

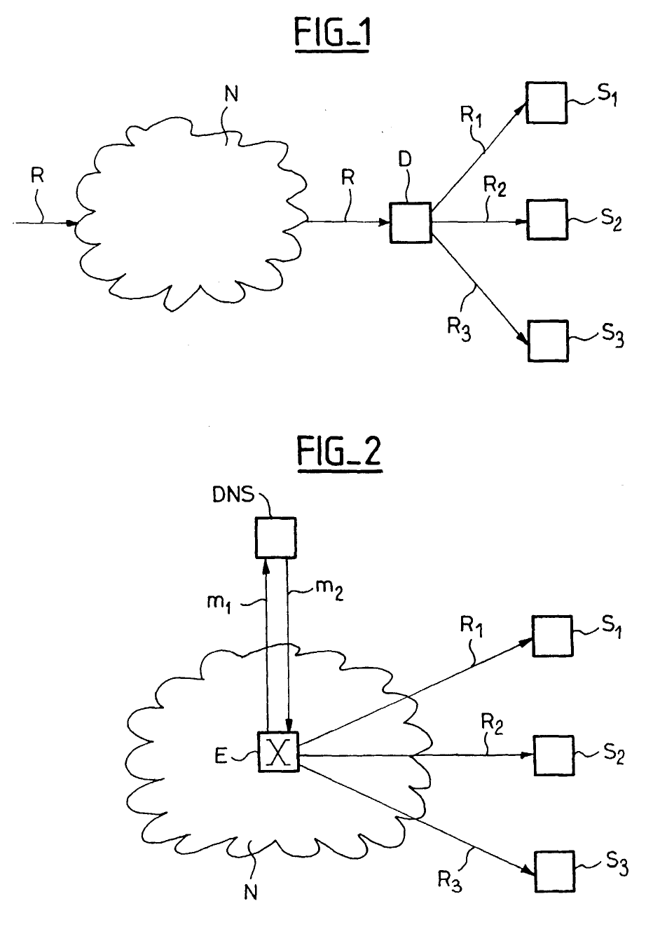

FIG. 2 shows a second prior art solution.

In the article previously mentioned, this solution is referred to “The DNS approach”.

The equipment E requires to transmit a service request. Conventionally, to find out the Internet Protocol (IP) address of the server implementing this service, it interrogates a domain name server (DNS) by means of a message m₁. In response, the domain name server DNS sends it a message m₂ containing the address. According to this solution, the domain name server can be modified and adapted to return the address of a different server as a function of a load distribution rule. Accordingly, as a function of the response of the domain name server, the network equipment E transmits a request R₁ to a server S₁, a request R₂ to a server S₂, or a request R₃ to a server S₃.

This solution distributes the load between servers at different locations in the network, but has other drawbacks. The first is that once a first interrogation of the domain name server DNS has been effected, the network equipment E stores (caches) the response. The next service request will not necessarily invoke the domain name server, in which case it will be directed to the same server without checking its load status.

Also, this solution is based on the hypothesis that the domain name server DNS is interrogated by the client and that the enquiry is addressed directly to the load distribution system. This hypothesis is not valid in all configurations, in particular if a firewall sends enquiries to the outside world instead of and in place of the client.

A third approach is disclosed by U.S. Pat. No. 6,370,584. In this solution, the various servers providing the same service handle distribution between them, i.e. without the aid of an external device. This kind of solution is unsatisfactory if the servers can be remote servers: this causes additional communication between the servers to reroute service requests, which can be prejudicial to the load of the telecommunication network and can also generate additional time-delays in the processing of service requests.

An object of the present invention is to alleviate the various problems to which the prior art solutions give rise.

To this end, the invention firstly consists in network equipment for transmitting data packets, some of which contain requests for a service implemented by a plurality of servers. According to the invention, the network equipment is characterized in that it includes means for receiving data packets containing or referring to executable code adapted to distribute the service requests among the plurality of servers and means for deciding to transmit the data packets to another network equipment or to execute the executable code.

The invention secondly consists in a management device associated with a plurality of servers connected to a network and implementing the same service. The management device is characterized in that it includes means for transmitting to network equipment executable code adapted to distribute the requests among the plurality of servers or references to the executable code.

The invention thirdly consists in a method of distributing the load within a plurality of servers connected to a network and implementing a service. The method is characterized in that it includes a step of transmitting data packets containing or referring to executable code adapted to be executed by equipment of the network and to distribute service requests among the plurality of servers.

In one embodiment of the invention, the plurality of servers is divided into a plurality of groups and each group is connected to a different equipment of the network.

Apart from solving the problems to which the prior art solutions give rise, the invention additionally facilitates managing the situation in which the servers are not connected to a single network equipment.

The invention and its advantages will become more clearly apparent in the following description of one embodiment of the invention, which is given with reference to the accompanying drawings.

FIGS. 1 and 2, already commented on, show two prior art solutions.

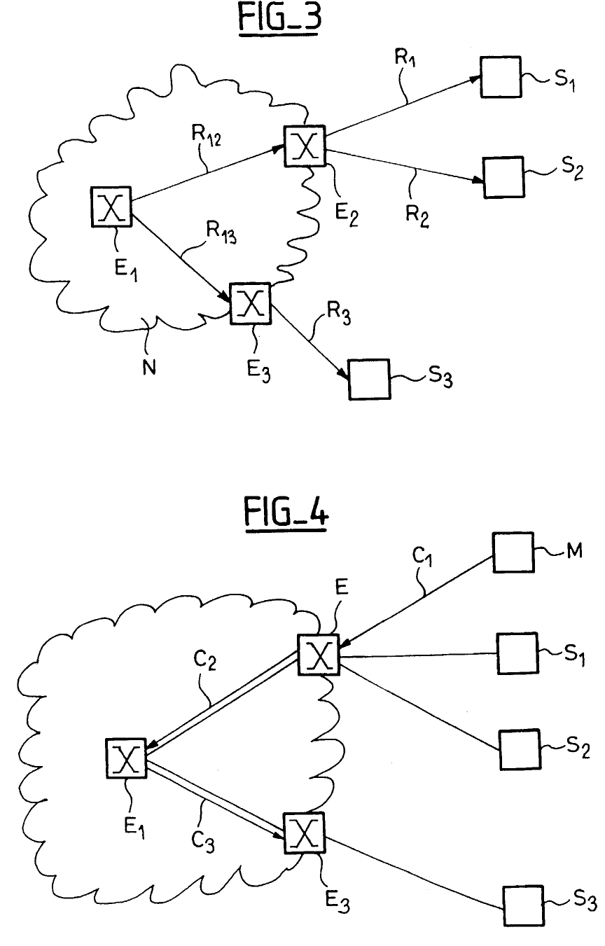

FIG. 3 shows how a load distribution mechanism according to the invention works.

FIG. 4 shows the installation of the mechanism according to the invention.

In FIG. 3, the network equipment E₁ receives a service request. For example, the network equipment is an IP router and the network N of which it is part is an Internet Protocol (IP) technology data network.

The network equipment E₁ has executable code adapted to distribute the request for service between two “output” network equipment E₂ and E₃.

For example, the distribution can conform to the resources of the servers associated with the paths corresponding to the network equipment E₁ and E₂. For example, if each server of the set of servers S₁, S₂ and S₃ has equivalent resources, the overall resource associated with the path to the network equipment E₂ is twice that associated with the path to the network equipment E₃.

A simple distribution rule can then be used to effect a statistical distribution of the request number to the two equipment E₂ and E₃, with a weighting of 2 for the equipment E₂ and a weighting of 1 for the equipment E₃. In other words, each service request reaching the equipment E₁ has a probability of ⅔ of being transmitted, according to a request R₁₂, to the equipment E₂, and a probability of ⅓ of being transmitted, according to a request R₁₃, to the equipment E₃.

The network equipment E₂ is connected to two servers S₁, S₂. In the same way as the network equipment E₁, it has an executable code adapted to distribute service requests reaching it.

For example, if the two servers S₁ and S₂ have equivalent resources, the executable code executed by the equipment E₂ can simply distribute incoming service requests R₁₂ with equal probability either to the server S₁, in the form of a request R₁, or to the server S₃, in the form of a request R₂.

Finally, the network equipment E₃ transmits normally incoming service requests R₁₃ to the server S₃, there being no load distribution at this location.

This example of the distribution rule implemented by the executable code is not limiting on the invention. Other heuristics are obviously possible, and likewise more sophisticated algorithms.

FIG. 4 shows one way in which the executable codes can be transmitted to the network equipment.

In one embodiment of the invention, the executable codes are transmitted by a management device M. Transmission can consist in:

either transmitting a data packet containing the executable code,

or transmitting a data packet containing a reference of the executable code. The executable code itself can be stored in the network equipment themselves or in an executable code server, not shown in the figure.

These two mechanisms conform to the general principles of the “active network” technology.

For example, the reference can be an identifier that identifies a unique executable code in an executable code server or in the network equipment itself.

If the data packet contains the executable code, the code can be adapted to execute on a common object request broker architecture (CORBA) software platform as specified by the Object Management Group (OMG), for example. This enables the executable code to interact in a more simple manner with the various software components previously installed on the network equipment.

The management device M is preferably adapted to transmit different executable codes to a plurality of network equipment: for example, it transmits an executable code c₁ to the equipment E₁, an executable code c₂ to an equipment E₂, and an executable code c₃ to an equipment E₃.

Thus the load distribution rules can easily be modified by transmitting a new executable code to the appropriate network equipment.

For example, if the server S₁ becomes unavailable or overloaded, the network equipment E₂ can be sent a new executable code adapted to transmit all service requests to the server S₂.

Given that in this case the distribution of resources is effected between the group of servers connected to the equipment E₂ and the group attached to the equipment E₃, a new executable code can also be transmitted to the equipment E₁.

The new active code can be adapted to transmit incoming service requests with equal probability to the equipment E₂ and the equipment E₃, for example.

Another advantage is that the management device M can be closely associated with the servers S₁, S₂, S₃. For example, it can regularly canvass the servers to obtain information from them in order to determine their load. On the basis of this information, it can determine new distribution rules to apply and the executable code to be transmitted to the appropriate equipment.

Moreover, thanks to the invention, it becomes possible to remove or add servers. For example, if a new server implementing the service is connected to the equipment E₃, the management device M can transmit a new executable code to the network equipment E₁ and E₃.

It is also possible to provide a plurality of management devices. Each of them can then manage some of the available servers. One distribution is for each management device to manage the servers that are topologically near it, for example in the same subnetwork. In this case, each management device is responsible for sending the executable code to the nearest network equipment, in order to distribute the loads in accordance with the chosen policy.

In one embodiment of the invention, the management device(s) M can be located on one of the servers S₁, S₂, S₃. For example, it can be a software module executed in that server.

1. Network equipment (E₁, E₂, E₃) for transmitting data packets, some of which contain requests for a service implemented by a plurality of servers (S₁, S₂, S₃), which network equipment is characterized in that it includes means for receiving data packets containing or referring to executable code adapted to distribute said service requests among said plurality of servers and means for deciding to transmit said data packets to another network equipment or to execute said executable code.

2. A management device (M) associated with a plurality of servers (S₁, S₂, S₃) connected to a network (N) and implementing the same service, which management device is characterized in that it includes means for transmitting to network equipment (E₁, E₂, E₃) executable code (c₁, c₂, C₃) adapted to distribute the requests among said plurality of servers or references to said executable code.

3. A method of distributing the load within a plurality of servers (S₁, S₂, S₃) connected to a network (N) and implementing a service, which method is characterized in that it includes a step of transmitting data packets containing or referring to executable code (c₁, c₂, C₃) adapted to be executed by equipment (E₁, E₂, E₃) of said network and to distribute service requests among said plurality of servers.

4. A method according to the preceding claim, wherein said plurality of servers is divided into a plurality of groups and each group is connected to a different equipment of said network.
